(19) United States
(12) Patent Application Publication
(10) Pub. No.: US 2017/0206918 A1
(43) Pub. Date: Jul. 20, 2017

(54) MAGNETIC RECORDING MEDIUM

(71) Applicant: FUJI ELECTRIC CO., LTD., Kawasaki-shi (JP)

(72) Inventors: Hitoshi Nakata, Sendai-shi (JP); Tomohiro Moriya, Sendai-shi (JP); Takehito Shimatsu, Sendai-shi (JP)

(21) Appl. No.: 15/477,434

(22) Filed: Apr. 3, 2017

Related U.S. Application Data
(63) Continuation of application No. PCT/JP2016/000009, filed on Jan. 4, 2016.

(30) Foreign Application Priority Data
Feb. 23, 2015 (JP) 2015-033336

(51) Int. Cl. G11B 5/65; G11B 5/31; C22C 5/04; G11B 5/73; G11B 5/245; G11B 5/66; H01F 10/13; H01F 10/12; G11B 5/64

(52) U.S. Cl. CPC G11B 5/653; H01F 10/123; G11B 5/3153; C22C 5/04; G11B 5/647; G11B 5/2455; G11B 5/66; H01F 10/138; G11B 5/7325

(57) ABSTRACT

The purpose of the present invention is to provide a magnetic recording medium capable of achieving high recording density by decreasing the bit transition width of a heat-assisted magnetic recording medium during the heat-assisted recording stage. The magnetic recording medium according to the present invention includes a non-magnetic substrate and a magnetic recording layer, wherein the magnetic recording layer includes an ordered alloy containing Fe, Pt and Ru, the ordered alloy includes x atom % of Fe, y atom % of Pt and z atom % of Ru on the basis of the total number of the Fe, Pt and Ru atoms, and the parameters x, y and z satisfy the following expressions (i)-(v): (i) 0.85≦x/y≦1.3; (ii) x≦53; (iii) y≦51; (iv) 0.6≦z≦20; and (v) x+y+z=100.

### CROSS-REFERENCE TO RELATED APPLICATION

This application is a continuation application of PCT Application No. PCT/JP2016/000009 filed on Jan. 4, 2016 under 37 Code of Federal Regulation §1.53 (b) and the PCT application claims the benefit of Japanese Patent Application No. 2015-033336 filed on Feb. 23, 2015, all of the above applications being hereby incorporated by reference wherein in their entirety.

### BACKGROUND OF THE INVENTION

Field of the Invention

The invention described in the present specification relates to a magnetic recording medium. Particularly, the invention described in the present specification relates to a magnetic recording medium utilized in an energy-assisted magnetic recording system. More particularly, the invention described in the present specification relates to a magnetic recording medium utilized in a heat-assisted magnetic recording system.

Description of the Related Art

Perpendicular magnetic recording system is adopted as a technique for increasing the magnetic recording density. A perpendicular magnetic recording medium at least comprises a non-magnetic substrate and a magnetic recording layer formed of a hard-magnetic material. Optionally, the perpendicular magnetic recording medium may further comprise: a soft-magnetic under layer which is formed of a soft-magnetic material and plays a role in concentrating the magnetic flux generated by a magnetic head onto the magnetic recording layer; a seed layer for orienting the hard-magnetic material in the magnetic recording layer in an intended direction; a protective film for protecting the surface of the magnetic recording layer; and the like.

For the purpose of further increasing the recording density of the perpendicular magnetic recording medium, a need for reduction in the grain diameter of the magnetic crystal grains in the magnetic recording layer arises in recent years. On the other hand, the reduction in the grain diameter of the magnetic crystal grains leads to a decrease in thermal stability of the recorded magnetization (signals). Thus, the magnetic crystal grains in the magnetic layer need to be formed of a material with higher magnetocrystalline anisotropy, in order to compensate the decrease in thermal stability due to the reduction in the grain diameter of the magnetic crystal grains.

As the material having the required higher magnetocrystalline anisotropy, L1₀ type ordered alloys have been proposed. International Patent Publication No. WO 2013/140469 describes L1₀ type ordered alloys comprising at least one element selected from the group consisting of Fe, Co and Ni and at least one element selected from the group consisting of Pt, Pd, Au and Ir. Typical L1₀ type ordered alloys include FePt, CoPt, FePd, CoPd, and the like.

However, the magnetic recording medium having the magnetic recording layer formed of the material of high magnetocrystalline anisotropy has large coercive force, and it is difficult record magnetization (signals) therein. In order to overcome the difficulty in recording, energy-assisted magnetic recording systems such as a heat-assisted recording system and a microwave-assisted recording system have been proposed. The heat-assisted recording system utilizes temperature dependency of the magnetic anisotropy constant (Ku) of the magnetic material, that is, a property that Ku decreases as the temperature rises. This system utilizes a head having a function to heat the magnetic recording layer. That is, writing is carried out while the temperature of the magnetic recording layer is raised to temporarily decrease Ku and thereby decreasing a magnetic switching field. After drop of the temperature, the recorded signals (magnetization) can be maintained stably, since Ku returns to the original large value. International Patent Publication No. WO 2013/140469 proposes a method for facilitating the heat-assisted magnetic recording by increasing the temperature gradient in the in-plane direction of the magnetic recording layer during recording.

In the case of using the heat-assisted recording system, it is necessary to provide a mean for heating the magnetic recording layer to a magnetic head used for recording. However, there are limitations on the adoptable heating mean, due to various requirements to the magnetic head. In view of this point, it is desirable to lower the heating temperature of the magnetic recording layer during recording as possible. One of indices of the heating temperature is Curie temperature Tc. The Curie temperature means a temperature at which the magnetism of the material is lost. Recording at a lower temperature becomes possible, by lowering the Curie temperature Tc of the material of the magnetic recording layer to decrease the magnetic anisotropy constant Ku at the given temperature.

However, there is a strong correlation between the Curie temperature Tc and magnetic anisotropy constant Ku of the magnetic material. Generally, material having a large magnetic anisotropy constant Ku exhibits a high Curie temperature Tc. Therefore, a higher priority has been previously put on lowering in the heating temperature, and the Curie temperature Tc has been lowered by decreasing the magnetic anisotropy constant Ku. In regard to this problem, Japanese Patent Laid-Open No. 2009-059461 proposes alleviation of the correlation between Ku and Tc by providing a plurality of magnetic layers in which respective magnetic layers have different Ku and Tc. In particular, this document proposes a magnetic recording layer comprising a first layer having a first Curie temperature Tc₁ and a second layer having a second Curie temperature Tc₂, wherein Tc₁ is higher than Tc₂. In this magnetic recording layer, it is possible to record magnetization into the first layer by heating the magnetic recording layer at a temperature not less than Tc₂ thereby dissipating exchange coupling between the first and second layers.

Besides, for the purpose of improving other various performance, introduction of various additional elements into the L1₀ type ordered alloys has been tried. For example, Japanese Patent Laid-Open No. 2003-313659 proposes a sintered target for sputtering, comprising elements constituting the L1₀ type ordered alloy and an additional element, in which a content of oxygen is not greater than 1000 ppm. It is described that the thin film formed with this target can achieve ordering of the L1₀ type ordered alloy at a lower annealing temperature. Especially, it is described that the ordering of the L1₀ type ordered alloy can be promoted in the cases where Cu, Au or the like is added. Further, Japanese Patent Laid-Open No. 2003-313659 discloses that separation of the magnetic crystal grains having the L1₀ type structure by a non-magnetic body contributes to improvement of the magnetic recording density. Non-magnetic elements and non-magnetic compound which is disposed around the magnetic crystal grains for magnetically separating them are listed. Various materials including Ru, Rh and the like are described as examples of such material.

On the other hand, United States Patent Application Publication No. 2003/0162055 proposes a magnetic recording layer consisting of polycrystalline ordered alloy which has a composition of (CoX)₃Pt or (CoX)₃PtY and an ordered structure different from the L1₀ type. Here, additional element X has an effect of migrating to crystalline boundaries to promote the magnetic separation of the magnetic crystal grains, and additional element Y has an effect of facilitating control of magnetic properties of the resultant polycrystalline ordered alloy, distribution of the magnetic crystal grains, and magnetic separation of the magnetic crystal grains. United States Patent Application Publication No. 2003/0162055 describes various materials including Ru, Rh and the like as examples of the additional element X.

However, it is a current state that studies of Ru as a material to be added to the ordered alloy has been little advanced. Studies of magnetic properties of the ordered alloy into which Ru is added, especially, studies of the gradient of an anisotropic magnetic field to temperature of such ordered alloy has been little advanced.

### SUMMARY OF THE INVENTION

The problem to be solved by the present invention is to provide a magnetic recording medium capable of achieving a high recording density by reducing a bit transition width during the heat recording of the heat-assisted magnetic recording medium. More specifically, the problem to be solved by the present invention is to provide a magnetic recording medium having a magnetic recording layer having a large gradient of an anisotropic magnetic field to temperature variation.

One of constitutional examples of the magnetic recording medium of the first embodiment of the present invention comprises a non-magnetic substrate and a magnetic recording layer, wherein the magnetic recording layer comprises an ordered alloy containing Fe, Pt and Ru, the ordered alloy comprises x atom % of Fe, y atom % of Pt and z atom % of Ru based on the total number of the Fe, Pt and Ru atoms, and x, y and z satisfy the following equations (i) to (v):

0.85≦x/y≦1.3; (i)

x≦53; (ii)

y≦51; (iii)

0.6≦z≦20; and (iv)

x+y+z=100. (v)

Here, the ordered alloy may be a L1₀ type ordered alloy. Further, the magnetic recording layer may have a granular structure comprising magnetic crystal grains comprising the ordered alloy and a non-magnetic crystal grain boundary. The non-magnetic crystal grain boundary may comprise at least one material selected from carbon, boron, a carbide, an oxide, and a nitride.

One of constitutional examples of the magnetic recording medium of the second embodiment of the present invention is the above-described constitutional example of the first embodiment, wherein the magnetic recording layer comprises a plurality of magnetic layers, and at least one of the magnetic layers is a magnetic layer comprising the ordered alloy. Here, the ordered alloy may be a L1₀ type ordered alloy. Further, the magnetic layer comprising the ordered alloy may have a granular structure comprising magnetic crystal grains comprising the ordered alloy and a non-magnetic crystal grain boundary. The non-magnetic crystal grain boundary may comprise at least one material selected from carbon, boron, a carbide, an oxide, and a nitride.

By adopting the above constitution, it becomes possible to provide a magnetic recording medium having a magnetic recording layer having a large gradient of the anisotropic magnetic field to temperature variation. The resultant magnetic recording medium exhibits a reduced bit transition width during heat recording, and can conform with magnetic recording in high density.

Further features of the present invention will become apparent from the following description of exemplary embodiments with reference to the attached drawings.

### BRIEF DESCRIPTION OF THE DRAWINGS

FIG. 1 is a cross-sectional diagram showing one of configuration examples of the magnetic recording medium of the first embodiment;

FIG. 2 is a cross-sectional diagram showing one of configuration examples of the magnetic recording medium of the second embodiment;

FIG. 3 is a graphical representation showing a relationship between the composition of the magnetic recording layer and a Curie temperature Tc;

FIG. 4 is a graphical representation showing a relationship between the composition of the magnetic recording layer and a gradient of an anisotropic magnetic field to temperature variation dHk/dT, at a temperature 60° C. lower than the Curie temperature Tc;

FIG. 5 is a graphical representation showing a relationship between the composition of the magnetic recording layer and a gradient of an anisotropic magnetic field to temperature variation dHk/dT, at a temperature 40° C. lower than the Curie temperature Tc;

FIG. 6 is a graphical representation showing a relationship between the composition of the magnetic recording layer and a gradient of an anisotropic magnetic field to temperature variation dHk/dT, at a temperature 20° C. lower than the Curie temperature Tc; and

FIG. 7 is a graphical representation showing a relationship between the composition of the magnetic recording layer and an anisotropic magnetic field Hk, at room temperature.

### DESCRIPTION OF THE EMBODIMENTS

One of constitutional examples of the magnetic recording medium of the first embodiment comprises a non-magnetic substrate and a magnetic recording layer, wherein the magnetic recording layer comprises an ordered alloy containing Fe, Pt and Ru, the ordered alloy comprises x atom % of Fe, y atom % of Pt and z atom % of Ru based on the total number of the Fe, Pt and Ru atoms, and x, y and z satisfy the following equations (i) to (v):

0.85≦x/y≦1.3; (i)

x≦53; (ii)

y≦51; (iii)

0.6≦z≦20; and (iv)

x+y+z=100. (v)

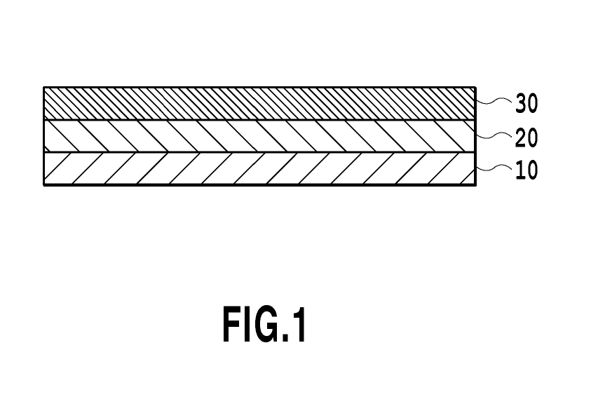

For example, the magnetic recording medium comprises non-magnetic substrate 10, magnetic recording layer 30, and seed layer 20 which may be optionally provided, in the constitutional example shown in FIG. 1.

The non-magnetic substrate 10 may be various substrates having a flat surface. For example, the non-magnetic substrate 10 may be formed of a material commonly used in magnetic recording media (such as NiP-plated Al alloy, monocrystalline MgO, tempered glass, or crystallized glass) or MgO.

The magnetic recording layer 30 may be a single layer. The magnetic recording layer 30 constituted from the single layer comprises an ordered alloy comprising Fe, Pt and Ru. The ordered alloy may be an L10 type ordered alloy. The contents x, y and z of Fe, Pt and Ru represented in a unit of atom % satisfy the above-described equations (i)-(v).

During heat recording stage in the heat-assisted recording system, the magnetic recording layer 30 is heated to the vicinity of a Curie temperature Tc, and records magnetization in the subsequent cooling stage. Hereinafter, the temperature at which the magnetization is actually recorded is referred to as “substantial recording temperature”. Besides, the Curie temperature Tc of the magnetic material means a temperature at which ferromagnetism of the magnetic material is lost. The Curie temperature Tc of magnetic crystal grains lowers in comparison with the Curie temperature Tc of bulk material, as the magnetic crystal grains are miniaturized. In addition, due to application of a recording magnetic field, writing and fixing of the magnetization can be conducted at a temperature lower than the Curie temperature Tc in the heat-assisted recording system.

In the heat-assisted recording system, a center of the heating spot by a heating mean installed on a head exists at a different position from the center of a writing magnetic pole. Generally, the heating mean includes a laser. Preferably, the distance between the center of the heating spot and the center of the writing magnetic pole is set to the order of a bit length. Therefore, the temperature at the center of the writing magnetic pole at which writing is actually carried out (that is, the substantial recording temperature) is lower than the highest heating temperature at the center of the heating spot. Difference between the substantial recording temperature and the highest heating temperature is estimated at the order of a product of a temperature gradient in the heating spot and the bit length. Table 1 shows relationship between the temperature gradient (° C./nm) and the bit length (nm), at some typical surface recording densities (terabits per square inch, Tbpsi) used in the magnetic recording medium for the heat-assisted recording system.

TABLE 1
Relationship between Temperature Gradient and Bit
Length at Typical Surface Recording Densities

| Surface Recording | Temperature | |
|---|---|---|
| Density | Gradient | Bit length |
| (Tbpsi) | (° C./nm) | (nm) |
| 2.0 | 14 | 9.0 |
| 3.0 | 16 | 8.5 |
| 4.0 | 18 | 8.0 |

The substantial recording temperature is about 140° C. lower than the highest heating temperature, in accordance with the relationship shown above. It is necessary to make the substantial recording temperature sufficiently close to the Curie temperature Tc, in order to conduct the heat-assisted magnetic recording. Therefore, it is necessary to set the highest heating temperature to a temperature sufficiently higher than the Curie temperature Tc. On the other hand, it is desirable to set the highest heating temperature as low as possible, in order to avoid excessive load to the heating mean. For example, as disclosed in H. J. Richter et. al., “Direct Measurement of the Thermal Gradient in Heat Assisted Magnetic Recording”, IEEE Transactions on Magnetics, Vol. 49, No. 10, pp. 5378-5381 (2013), the highest heating temperature is generally set to a temperature about 100° C. higher than the Curie temperature Tc. As a result, the substantial recording temperature is set to a temperature about 40° C. lower than the Curie temperature Tc.

The actual substantial recording temperature varies dependent on the design principle of the magnetic recording device and the like. Preferably, it is assumed that the substantial recording temperature is within a range from a temperature 60° C. lower than the Curie temperature Tc to a temperature 20° C. lower than the Cutie temperature Tc, the middle of the range being a temperature 40° C. lower than the Curie temperature Tc.

It is necessary to increase the gradient of an anisotropic magnetic field (Hk) to temperature variation (dHk/DT) at the substantial recording temperature, in order to improve the recording density. This is because the bit transition width between recording bits can be reduced by increasing dHk/dT. The “bit transition between recording bits” in the magnetic recording medium means a region between a region where magnetization directs perpendicularly upward and a region where magnetization directs perpendicularly downward. In accordance with Masukazu Igarashi et. al., “Computer Simulation for Thermal Assist Recording—The Format of Technical Report (Subtitle)—”, Technical Report of IEICE, MR2004-39 (2004-12), the bit transition width is defined by a length that magnetization of the adjacent bit does not change during recording, more particularly the bit transition width is 0.5×(bit length). In representing the recording magnetic field by Hsw and the dispersion of the gradient of the recording magnetic field by σHsw, the bit transition width is obtained by an equation of:

5×(2×σHsw)/(dHsw/dT)

when estimating the bit transition width in an accuracy of 5σ. Here, the gradient of the recording magnetic field dHsw/dx is obtained by an equation of:

dHsw/dx=(dHsw/dT)×(dT/dx),

and approximately dHsw/dT is obtained by an equation of:

dHsw/dT=0.5×(dHk/dT).

Under the conditions assumed in the current heat-assisted magnetic recording system, that is, the temperature gradient dT/dx of 5° C./nm, the recording magnetic field Hsw of 2.5 kOe (about 199 A/mm), and the normalized dispersion of the recording magnetic field σHsw/Hsw of 7%, dHk/dT is preferably larger than 170 Oe/° C. (13.5 A/mm·° C.) for achieving the bit length of 8.0 nm for the surface recording density of 4.0 Tbpsi. Therefore, it is required to satisfy the condition of dHk/dT>170 Oe/° C. (13.5 A/mm·° C.) throughout the range of the assumed substantial recording temperature. The above requirement can be satisfied by setting dHk/dT higher than 170 Oe/° C. (13.5 A/mm·° C.) at a temperature 60° C. lower than the Curie temperature, since magnetic recording in the heat-assisted magnetic recording system becomes more difficult, as the substantial recording temperature goes down. The present inventors have found that the above requirement can be satisfied by using the FePtRu ordered alloy which satisfies the above-described equations (i) to (v).

Besides, a low Tc can be obtained while a high Ku is maintained, by constituting the ordered alloy of the magnetic recording layer 30 with the use of Ru as the third element. The reason for this fact has not been sufficiently elucidated. Not bound to any theory, the reason can be considered as follows.

It is well known that antiferromagnetic exchange coupling is achieved in adjacent ferromagnetic layers, by interposing a thin coupling layer consisting of non-magnetic transition metal such as Ru, Cu, Cr and the like between the ferromagnetic layers. Antiferromagnetic coupling potential varies dependent on the type of atom, constitution of the interposed layer and the like. In comparison of the maximum values of the antiferromagnetic exchange coupling potential for respective atoms, the maximum value increase when Ru is used as the coupling layer. The antiferromagnetic exchange coupling potential when Ru is used is especially high, as ten times high as those of the cases where other atoms such as Cu are used. Further, it is known that Ru can exert the above-described effect in a small thickness. In accordance with experiments by the present inventors, it is found that saturated magnetization Ms becomes small at the same Ku when adding Ru to the ordered alloys such as FePt, in comparison with the cases where other atoms such as Cu are added. Taking the above points into account comprehensively, it is supposed that a phenomenon of generating spin couples having opposite spin direction occurs via the added Ru, which is similar to the antiferromagnetic coupling. Thus, overall spin disturbance is likely to occur at a relatively low temperature by generating antiferromagnetic-like coupling via Ru used as the third element in a part of the interior of the ordered alloy, and thereby Tc is lowered.

In this embodiment, all of the atoms in the ordered alloy do not necessarily possess the ordered structure. If an alloy has an order parameter S, which indicates the extent of the ordered structure, larger than the predetermined value, the alloy can be used as the ordered alloy of this embodiment. The order parameter S is determined by measuring the magnetic thin film by an X-ray diffraction method (XRD), and calculating a ratio between the measured value and a theoretical value in a completely ordered state. For the L1₀ type ordered alloy, the order parameter S is calculated with integrated intensities of (001) and (002) peaks derived from the ordered alloy. The order parameter S is determined as a square root of quotient of a ratio of the measured integrated intensity of the (001) peak to that of the (002) peak divided by a theoretically calculated ratio of the integrated intensity of the (001) peak to that of the (002) peak in the case where the ordered alloy is completely ordered. If such obtained order parameter S is not less than 0.5, the ordered alloy will have a magnetic anisotropy constant Ku practical for the magnetic recording medium.

Alternatively, the magnetic recording layer 30 consisting of a single layer may have a granular structure consisting of magnetic crystal grains consisting of the above-described ordered alloy and a non-magnetic crystal grain boundary surrounding the magnetic crystal grains. The material for constituting the non-magnetic crystal grain boundary includes carbon, boron, a carbide, an oxide and a nitride. The oxide used in the non-magnetic crystal grain boundary includes SiO₂, TiO₂ and ZnO. The nitride used in the non-magnetic crystal grain boundary includes SiN and TiN. In the granular structure, each of the magnetic crystal grains is magnetically separated by the non-magnetic crystal grain boundary. This magnetic separation is effective to improve an SNR of the magnetic recording medium.

One or more of the forth elements may be introduced into the ordered alloy used in this embodiment. Various elements can be uses as the fourth element, as long as they do not impede the effect of Ru. For example, non-limiting examples of the fourth element include, Ag, Cu, Co, Mn, Cr, Ti, Zr, Hf, Nb, Ta, Al and Si.

The magnetic recording layer 30 is preferably formed by a sputtering method involving heating of the substrate. The substrate temperature during formation of the magnetic recording layer is preferably within a range from 300° C. to 800° C. Especially preferably, the substrate temperature is within a range from 400° C. to 500° C. By adopting the substrate temperature within this range, the order parameter S of the L1₀ type ordered alloy material in the magnetic recording layer can be improved. Alternatively, a sputtering method using two targets which are a target consisting of Fe and Pt and a target consisting of Ru may be adopted. Alternatively, a sputtering method using three targets which are a target consisting of Fe, a target consisting of Pt, and a target consisting of Ru may be adopted. In these cases, the ratio of Fe, Pt and Ru in the ordered alloy in the magnetic recording layer 30 can be controlled by separately applying electric power to respective targets.

In formation of the magnetic recording layer 30 having a granular structure, a target in which a material for forming the magnetic crystal grains and a material for forming the non-magnetic crystal grain boundary are mixed in a predetermined ratio may be used. Alternatively, a target consisting of the material for forming the magnetic crystal grains and a target consisting of the material for forming the non-magnetic crystal grain boundary may be used. As described above, a plurality of targets may be used as a target for forming the magnetic crystal grains. In this case, the ratio between the magnetic crystal grains and the non-magnetic crystal grain boundary in the magnetic recording layer 30 can be controlled by separately applying electric power to respective targets.

One of the constitutional examples of the magnetic recording medium of the second embodiment differs from the magnetic recording medium of the first embodiment, in that the magnetic recording layer consists of a plurality of magnetic layers. At least one of the magnetic layers comprises the FePtRu ordered alloy satisfying the equations (i) to (v) described in the first embodiment. In the present specification, the magnetic layer comprising the ordered alloy explained in the first embodiment is referred to as “magnetic layer A”. The magnetic layer A may have either a non-granular structure or a granular structure. In the case where the magnetic recording layer comprise a plurality of the magnetic layers A, each of the magnetic layers A may independently have either of the granular structure or the non-granular structure. Desirably, the magnetic layer A has the granular structure.

The magnetic recording layer of this embodiment may comprise at least one magnetic layer not comprising the above-described ordered alloy. In other words, at least one of the plurality of magnetic layers, other than the magnetic layer A, may not comprise the above-described ordered alloy. In the present specification, the magnetic layer not comprising the above-described ordered alloy is referred to as “magnetic layer B”. The magnetic layer B may have either a non-granular structure or a granular structure. In the case where the magnetic recording layer comprise a plurality of the magnetic layers B, each of the magnetic layers B may independently have either of the granular structure or the non-granular structure. For example, the magnetic layer B may comprise an ordered alloy comprising at least one of a first element selected from the group consisting of Fe, Co and Ni and at least one of a second element selected from the group consisting of Pt, Pd, Au and Ir. In other words, the magnetic layer B may be a layer not comprising the Ru-containing ordered alloy. The ordered alloy may be an L1₀ type ordered alloy. Preferable L1₀ type ordered alloy includes FePt, CoPt, FePd and CoPd. Especially preferable L1₀ type ordered alloy is FePt.

For example, the magnetic layer B may be a layer having a different Curie temperature Tc from that of the magnetic layer A, the purpose of which is control of Tc. The magnetic layer B for controlling Tc desirably has the granular structure. The magnetic crystal grains of the magnetic layer B having the granular structure may be formed of a magnetic material comprising at least one of Co and Fe, for example. Further, it is preferable that this magnetic material further comprises at least one of Pt, Pd, Ni, Mn, Cr, Cu, Ag and Au. For example, the magnetic layer B for controlling Tc can be formed of a CoCr-based alloy, a CoCrPt-based alloy, an FePt-based alloy, an FePd-based alloy or the like. The crystalline structure of the magnetic material may be an ordered structure such as L1₀ type, L1₁ type, or L1₂ type, an hcp structure, an fcc structure, or the like. Besides, the non-magnetic crystal grain boundary may comprise: carbon; boron; an oxide selected from the group consisting SiO₂, TiO₂ and ZnO; or a nitride selected from the group consisting of SiN and TiN.

Alternatively, the magnetic layer B may be a CAP layer. The CAP layer may be a magnetically continuous layer in the layers of the magnetic layers. Magnetization reversal as the magnetic recording medium can be adjusted by disposing this magnetically continuous layer. The material of the magnetically continuous layer is preferably a material comprising at least one of Co and Fe, and, more preferably, the material further comprising at least one of Pt, Pd, Ni, Mn, Cr, Cu, Ag, Au, and a rare-earth element. For example, a CoCr-based alloy, a CoCrPt-based alloy, an FePt-based alloy, an FePd-based alloy, a CoSm-based alloy, or the like can be used. The continuous layer may be either polycrystalline or amorphous. The crystalline structure may be an ordered structure such as L1₀ type, L1₁ type, or L1₂ type, an hcp structure (hexagonal closest packed structure), an fcc structure (face-centered cubic structure), or the like, in the cases where the continuous layer consists of the polycrystalline material.

Alternatively, in the magnetic recording layer of this embodiment, an exchange coupling controlling layer may be disposed between two magnetic layers for adjusting magnetic exchange coupling between the two magnetic layers. The magnetic switching field can be adjusted by adjusting the magnetic exchange coupling at the recording temperature. The exchange coupling controlling layer may be either of a layer exhibiting magnetism or a non-magnetic layer, dependent on desired exchange coupling. It is preferable to use the non-magnetic layer in order to enhance an effect of reducing the magnetic switching field at the recording temperature.

The magnetic layer B has a function to maintain magnetization corresponding to information intended to be recorded (for example, information of 0 or 1) in cooperation with the magnetic layer A at a temperature where the information is stored, and/or a function of facilitating recording in cooperation with the magnetic layer A at a temperature where the information is recorded. In order to attain this purpose, other magnetic layers can be added, instead of the above-described Tc control magnetic layer and/or CAP layer, or in addition to the above-described Tc control magnetic layer and/or CAP layer. For example, a magnetic layer for modifying magnetic properties, or a magnetic layer for controlling ferromagnetic resonance frequency for microwave-assisted magnetic recording may be added. Here, the magnetic properties to be modified includes a magnetic anisotropy constant Ku, a magnetic switching field, coercive force Hc, saturation magnetization Ms, and the like. The magnetic layer to be added may be a single layer, or may have a stacked structure of layers which are different in composition or the like. Alternatively, a plurality of the magnetic layers B having different constitutions may be added.

In the magnetic recording layer of this embodiment, at least one of the plurality of magnetic layer desirably has the granular structure. The layer having the granular structure may be the magnetic layer A or the magnetic layer B. Further, in the case where two magnetic layers having the granular structure are adjacent with each other, it is desirable that the material for forming the non-magnetic crystal grain boundaries of these layers is different from each other. By forming the non-magnetic crystal grain boundaries of the adjacent magnetic layers from different material, it becomes possible to promote columnar growth of the magnetic crystal grains in the magnetic layers, and thereby to improve the order parameter of the ordered alloy and to improve magnetic separation of the magnetic crystal grains.

Among the plurality of magnetic layers constituting the magnetic recording layer of this embodiment, the layers not containing the ordered alloy can be formed by any method known in the art, such as a sputtering method (including a DC magnetron sputtering method), or a vacuum deposition method. In forming a layer having a granular structure but not containing the ordered alloy, the sputtering method using a target in which a material for forming the magnetic crystal grains and a material for forming the non-magnetic crystal grain boundary are mixed in a predetermined ratio may be used, as explained in the first embodiment. Alternatively, the layer having the granular structure may be formed by a sputtering method using a target consisting of the material for forming the magnetic crystal grains and a target consisting of the material for forming the non-magnetic crystal grain boundary. On the other hand, among the plurality of magnetic layers, layers comprising the ordered alloy are preferably formed by a sputtering method involving heating of the substrate, as explained in the first embodiment.

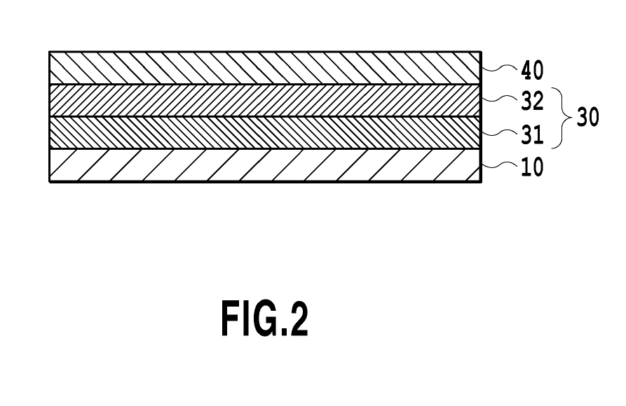

In one of constitutional examples of the magnetic recording medium of the second embodiment, the magnetic recording layer consists of a first magnetic layer and a second magnetic layer. The second magnetic layer is formed on the first magnetic layer. In the constitutional example shown in FIG. 2, the magnetic recording medium comprises the non-magnetic substrate 10, the magnetic recording layer 30 consisting of the first magnetic layer 31 and the second magnetic layer 32, and protective layer 40 which may be optionally disposed.

The first magnetic layer 31 has a granular structure comprising magnetic crystal grains and a non-magnetic crystal grain boundary. The magnetic crystal grains in the first magnetic layer 31 does not comprise the FePtRu ordered alloy satisfying the equations (i) to (v) explained in the first embodiment. In particular, the magnetic crystal grains in the first magnetic layer 31 are formed of an ordered alloy consisting of at least one first element selected from the group consisting of Fe, Co and Ni, and at least one second element selected from the group consisting of Pt, Pd, Au and Ir. The ordered alloy may be an L1₀ type ordered alloy. Preferable L1₀ type ordered alloy includes FePt, CoPt, FePd and CoPd. Especially preferable L1₀ type ordered alloy is FePt.

Further, the non-magnetic crystal grain boundary in the first magnetic layer 31 comprises carbon. Preferably, the non-magnetic crystal grain boundary in the first magnetic layer 31 consists of carbon. In the case where the above-described ordered alloy is used, carbon is a material having superior diffusibility, and rapidly migrates from the position of the magnetic crystal grains to the non-magnetic body in comparison with an oxide, a nitride, and the like. As a result, the magnetic crystal grains separate well from carbon, to improve the order parameter of the ordered alloy constituting the magnetic crystal grains. Further, uniform magnetic crystal grains can be readily formed.

The first magnetic layer 31 desirably has a thickness from 0.5 to 4 nm, preferably from 1 to 2 nm. By adopting the thickness within this range, it become possible to achieve both of improvement of the order parameter and improvement of magnetic separation, in the magnetic crystal grains. Besides, the first magnetic layer 31 desirably has the thickness within the above-described range, also in order to prevent to diffuse carbon up to the top surfaces of the magnetic crystal grains.

The second magnetic layer 32 has a granular structure comprising magnetic crystal grains and a non-magnetic crystal grain boundary. The magnetic crystal grains in the second magnetic layer 32 comprises the ordered alloy explained in the first embodiment. In particular, the ordered alloy comprises Fe, Pt and Ru, and has a composition satisfying the equations (i) to (v) described above. The ordered alloy may have an L1₀ type ordered structure.

Further, the non-magnetic crystal grain boundary in the second magnetic layer 32 comprises SiO₂ or a mixture of carbon and boron. Preferably, the non-magnetic crystal grain boundary in the second magnetic layer 32 consists of SiO₂ or a mixture of carbon and boron. That is, the non-magnetic crystal grain boundary in the second magnetic layer 32 is formed of the material different from that of the non-magnetic crystal grain boundary in the first magnetic layer 31. Columnar growth of the magnetic crystal grain in the second magnetic layer 32 onto the magnetic crystal grain in the first magnetic layer 31 becomes possible by forming the non-magnetic crystal grain boundaries in the first magnetic layer 31 and the second magnetic layer 32 from different materials. Magnetic crystal grains passing through the thicknesses of the first magnetic layer 31 and the second magnetic layer 32 are formed, by forming the magnetic crystal grain in the second magnetic layer 32 onto the magnetic crystal grain in the first magnetic layer 31. Formation of such magnetic crystal grains reduces exchange interaction between the adjacent magnetic crystal grains. This effect allows high-density magnetic recording to the magnetic recording medium.

The second magnetic layer 32 desirably has a thickness from 0.5 to 10 nm, preferably from 3 to 7 nm. By adopting the thickness within this range, it become possible to achieve improvement of the order parameter in the magnetic crystal grains. Further, formation of giant crystal grain due to coalescence of the magnetic crystal grains in the second magnetic layer 32 can be prevented by adopting the thickness within this range, to improve magnetic separation of the magnetic crystal grains in the second magnetic layer 32.

The magnetic recording medium described in the present specification may further comprise one or more layers selected from the group consisting of an adhesive layer, a heat sink layer, a soft-magnetic under layer, an interlayer, and seed layer 20, between the non-magnetic substrate 10 and the magnetic recording layer 30. In addition, the magnetic recording medium described in the present specification may further comprise protective layer 40 on the magnetic recording layer 30. Further, the magnetic recording medium described in the present specification may further comprise a liquid lubricant layer on the magnetic recording layer 30 or the protective layer 40.

The adhesive layer, which may be formed optionally, is used for enhancing the adhesion between the layer formed on it and the layer formed under it (including the non-magnetic substrate 10). In the case where the adhesive layer is disposed on the top surface of the non-magnetic substrate 10, the adhesive layer can be formed of a material having favorable adhesion to the above-described material of the non-magnetic substrate 10. Such material includes a metal such as Ni, W, Ta, Cr or Ru, or an alloy containing the above-described metals. Alternatively, the adhesive layer may be disposed between two constituent layers other than the non-magnetic substrate 10. The adhesive layer may be a single layer or have a stacked structure with plural layers.

The soft-magnetic under layer, which may be formed optionally, controls the magnetic flux emitted from a magnetic head to improve the read-write characteristics of the magnetic recording medium. The material for forming the soft-magnetic under layer includes: a crystalline material such as a NiFe alloy, a sendust (FeSiAl) alloy, or a CoFe alloy; a microcrystalline material such as FeTaC, CoFeNi or CoNiP; and an amorphous material including a Co alloy such as CoZrNb or CoTaZr. The optimum thickness of the soft-magnetic under layer depends on the structure and characteristics of the magnetic head used in magnetic recording. When forming the soft-magnetic under layer continuously with other layers, the soft-magnetic under layer preferably has a thickness in a range from 10 nm to 500 nm (both inclusive), in view of productivity.

A heat sink layer may be provided, when the magnetic recording medium is used in a heat-assisted magnetic recording system. The heat sink layer is a layer for effectively absorbing excess heat of the magnetic recording layer 30 generated during heat-assisted magnetic recording. The heat sink layer can be formed of a material having a high thermal conductivity and a high specific heat capacity. Such material includes a Cu simple substance, an Ag simple substance, an Au simple substance, or an alloy material composed mainly of these substances. As used herein, the expression “composed mainly of” means that the content of the concerned material is 50% by weight or more. In consideration of its strength or the like, the heat sink layer can be formed of an Al—Si alloy, a Cu—B alloy, or the like. Further, the function of the soft-magnetic under layer, that is, the function of concentrating a perpendicular magnetic field generated by the head, can be imparted to the heat sink layer, by forming the heat sink layer from a sendust (FeSiAl) alloy, a soft-magnetic CoFe alloy, or the like. The optimum thickness of the heat sink layer depends on the amount and distribution of heat generated during heat-assisted magnetic recording, as well as the layer configuration of the magnetic recording medium and the thickness of each constituent layer. When forming the heat sink layer continuously with other constituent layers, the heat sink layer preferably has a thickness of 10 nm or more and 100 nm or less, in view of productivity. The heat sink layer can be formed by any process known in the art, such as a sputtering method (including a DC magnetron sputtering method) or a vacuum deposition method. Normally, the heat sink layer is formed by the sputtering method. The heat sink layer can be disposed between the non-magnetic substrate 10 and the adhesive layer, between the adhesive layer and the interlayer, or the like, in consideration of characteristics required for the magnetic recording medium.

The interlayer is a layer for controlling the crystallinity and/or the crystalline orientation of the seed layer 20 formed on or above the interlayer. The interlayer may be a single layer or may consist of a plurality of layers. Preferably, the interlayer is a non-magnetic film formed of a Cr metal, or alloys in which at least one metal selected from the group consisting of Mo, W, Ti, V, Mn, Ta and Zr is added to the principal ingredient Cr. The interlayer can be formed by any process known in the art, such as a sputtering method.

The function of the seed layer 20 is to ensure adhesion between the magnetic recording layer 30 and the layer underlying the seed layer 20 such as the interlayer, and to control the grain diameter and the crystalline orientation of the magnetic crystal grains in the magnetic recording layer 30 which is an upper layer of the seed layer 20. The seed layer 20 is preferably non-magnetic. In addition, in the case where the magnetic recording medium described in the present specification is used in the heat-assisted magnetic recording system, it is preferable that the seed layer 20 controls the temperature rise and the temperature distribution of the magnetic recording layer 30, as a thermal barrier. In order to control the temperature rise and the temperature distribution of the magnetic recording layer 30, the seed layer 20 preferably has both of a function to rapidly raise the temperature of the magnetic recording layer 30 during heating of the magnetic recording layer 30 in heat-assisted recording, and a function to transfer the heat of the magnetic recording layer 30 to the underlying layer such as the interlayer via heat transfer in the depth direction before heat transfer in the in-plane direction in the magnetic recording layer 30 occurs.

In order to achieve the above-described functions, the material of the seed layer 20 is appropriately selected in accordance with the material of the magnetic recording layer 30. More particularly, the material of the seed layer 20 is selected in accordance with the material of the magnetic crystal grains in the magnetic recording layer 30. If the magnetic crystal grains in the magnetic recording layer 30 is formed of the L1₀ type ordered alloy, the seed layer 20 is preferably formed of a Pt metal, or an NaCl type compounds. Especially preferably, the seed layer 20 is formed of an oxide such as MgO, or SrTiO₃, or a nitride such as TiN. In addition, the seed layer 20 can be formed by stacking a plurality of layers consisting of the above-described materials. The seed layer 20 preferably has a thickness from 1 nm to 60 nm, more preferably from 1 nm to 20 nm, in view of improvement in crystallinity of the magnetic crystal grains in the magnetic recording layer 30, and improvement in productivity. The seed layer 20 can be formed by any process known in the art, such as a sputtering method (including an RF magnetron sputtering method and a DC magnetron sputtering method) or a vacuum deposition method.

The protective layer 40 can be formed of a material conventionally used in the field of magnetic recording media. Specifically, the protective layer 40 can be formed of a non-magnetic metal such as Pt, a carbon-based material such as diamond-like carbon, or a silicon-based material such as silicon nitride. The protective layer 40 may be a single layer or have a stacked structure. The stacked structure of the protective layer 40 may be a stacked structure of two types of carbon-based material having different characteristics from each other, a stacked structure of a metal and a carbon-based material, or a stacked structure of a metallic oxide film and a carbon-based material, for example. The protective layer 40 can be formed by any process known in the art such as a sputtering method (including a DC magnetron sputtering method or the like), a CVD method, or a vacuum deposition method.

The liquid lubricant layer can be formed of a material conventionally used in the field of magnetic recording media (for example, perfluoropolyether-based lubricants or the like). The liquid lubricant layer can be formed by a coating method such as a dip-coating method or a spin-coating method, for example.

### EXAMPLE

A monocrystalline (001) MgO substrate having a flat surface was washed to prepare non-magnetic substrate 10. The washed non-magnetic substrate 10 was brought into a sputtering device. The non-magnetic substrate was heated to a temperature of 350° C., and then Pt seed layer 20 having a thickness of 20 nm was formed by an RF magnetron sputtering method using a Pt target disposed at the distance of 320 mm from the non-magnetic substrate 10 in Ar gas at a pressure of 0.44 Pa.

Next, the non-magnetic substrate 10 on which the seed layer 20 had been formed was heated to a temperature of 350° C., and then FePtRu magnetic recording layer 30 having a thickness of 10 nm was formed by an RF magnetron sputtering method using an FePt target and an Ru target in Ar gas at a pressure of 0.60 Pa, to obtain a magnetic recording medium having the structure shown in FIG. 1. Here, the FePt and Ru targets were disposed at the distance of 320 nm from the non-magnetic substrate 10. Further, the Fe content x (atom %) and the Pt content y (atom %) in the magnetic recording layer were adjusted by using FePt targets having various compositions. Further, the Ru content z (atom %) in the magnetic recording layer were adjusted by fixing the electric power applied to the FePt target to 300 W and varying the electric power applied to the Ru target from 0 to 240 W. The compositions of the resultant magnetic recording media are shown in Tables 2 to 6. Besides, it was confirmed that the magnetic recording layer 30 consisted of an L1₀ type ordered alloy, by XRD of the magnetic recording layer 30 of each of the resultant samples.

Saturated magnetization Ms of the resultant magnetic recording media was measured by a vibrating sample magnetometer (VSM). Further, the resultant magnetic recording media was heated to a range from room temperature (25° C.) to 400° C., and saturated magnetization Ms(T) at each of the temperature T by the vibrating sample magnetometer (VSM). The measuring temperature T and the square of the saturated magnetization Ms²(T) were plotted, and a regression curve was obtained by a method of least squares. The resultant regression curve was extrapolated to the point of Ms²=0 to obtain a Curie temperature Tc. The Curie temperature Tc of each of the samples are shown in Tables 2 to 6.

Further, the magnetic anisotropy constant (Ku) of the resultant magnetic recording layer 30 was obtained by using anomalous Hall effect. Specifically, a magnetic torque curve was measured under an external magnetic field of 7 T at room temperature (25° C.), and the magnetic anisotropy constant Ku(RT) at room temperature was calculated by fitting of the resultant torque curve. The abbreviation “RT” means room temperature (25° C.).

Subsequently, a magnetic anisotropy constant Ku(T) at the desired temperature T was obtained based on Equation (1).

Ku(T)=Ku(RT)×[Tc−T]/[Tc−RT] (1)

Further, an anisotropic magnetic field Hk(T) at temperature T was obtained from the saturated magnetization Ms(T) and the magnetic anisotropy constant Ku(T) at the desired temperature T based on Equation (2).

Hk(T)=2×Ku(T)/Ms(T) (2)

Finally, the gradient of the anisotropic magnetic field to temperature variation dHk/dT was obtained based on the value of Hk(T) in the vicinity of the standard temperature. In this example, a temperature 60° C. lower than the Curie temperature, a temperature 40° C. lower than the Curie temperature, and a temperature 20° C. lower than the Curie temperature were used as the standard temperature. The gradients of the anisotropic magnetic field to temperature variation dHk/dT of each of the samples are shown in Tables 2 to 6. In addition, Hk of each of the samples at room temperature is shown in Tables 2 to 6.

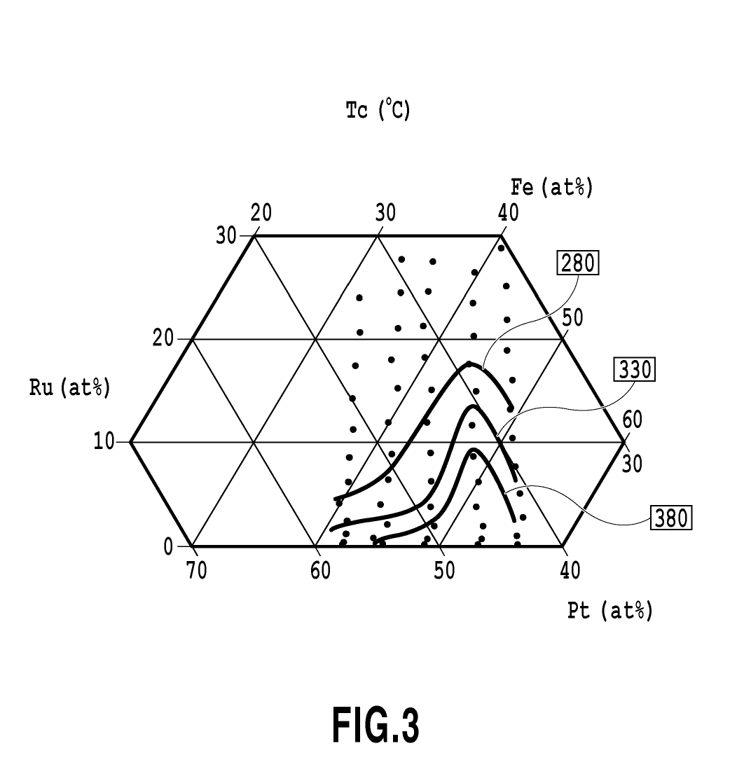

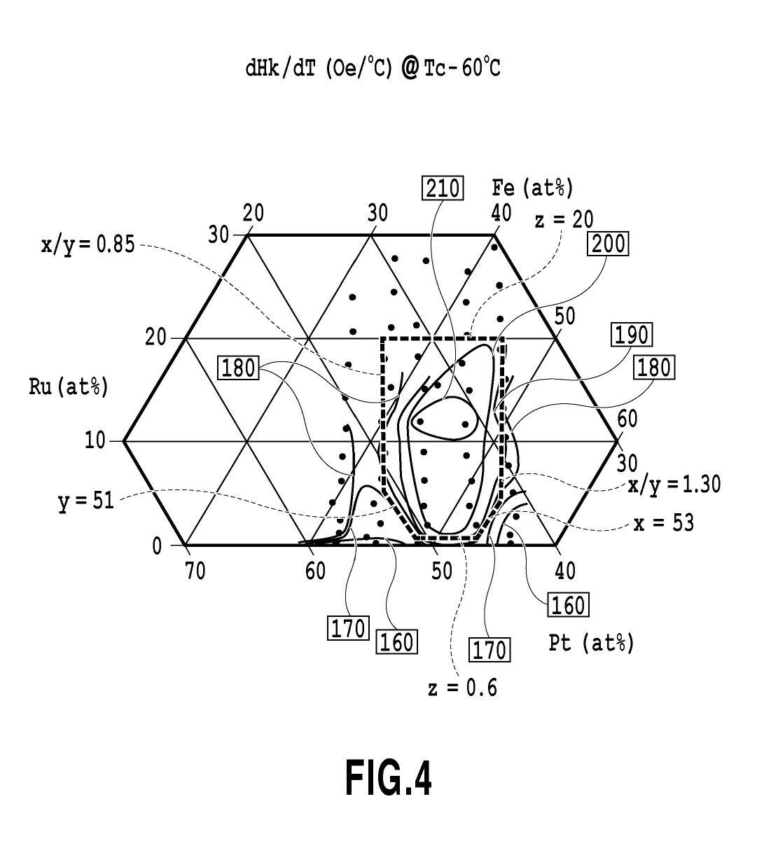

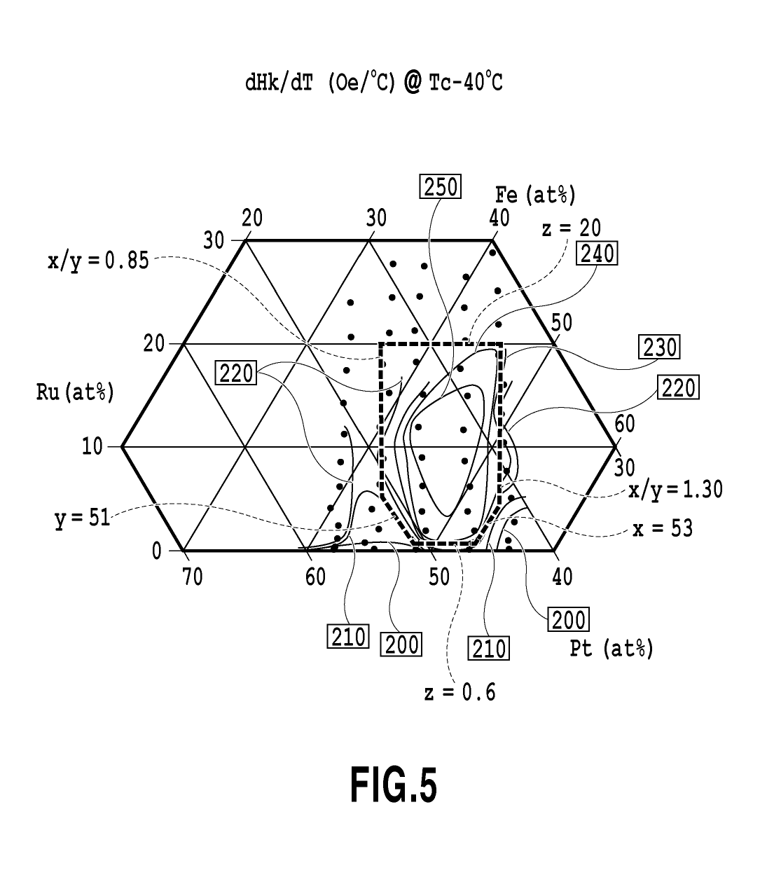

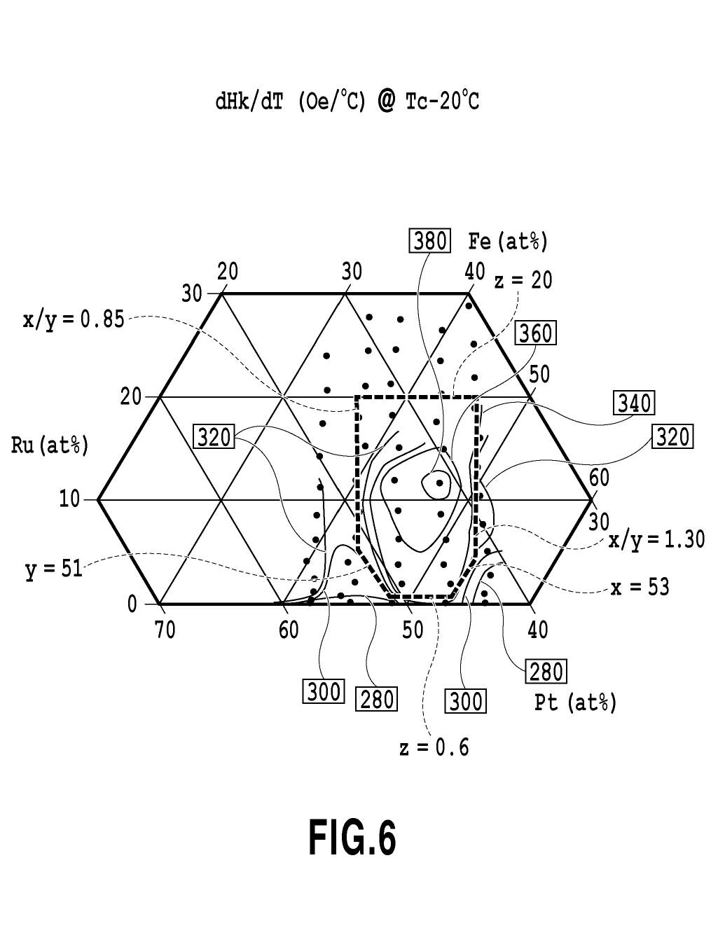

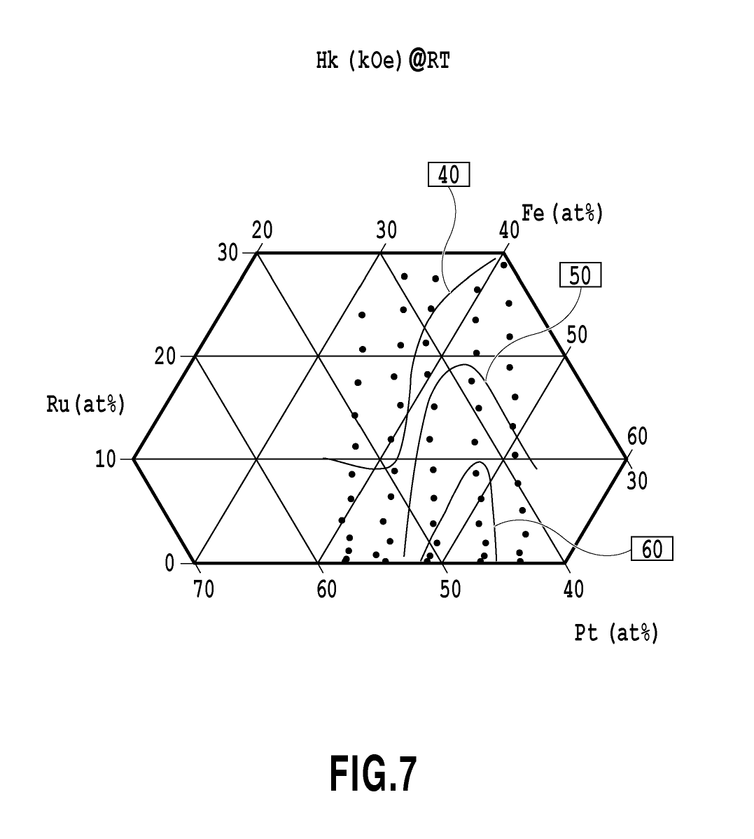

FIG. 3 shows variation of the Curie temperature Tc to the composition of the magnetic recording layer, with contour lines. FIGS. 4 to 6 show variation of the gradients of the anisotropic magnetic field to temperature variation dHk/dT, with contour lines. FIG. 4 shows variation of dHk/dT at the temperature 60° C. lower than the Curie temperature Tc, FIG. 5 shows variation of dHk/dT at the temperature 40° C. lower than the Curie temperature Tc, and FIG. 6 shows variation of dHk/dT at the temperature 20° C. lower than the Curie temperature Tc. FIG. 7 shows variation of the anisotropic magnetic field Hk to the composition of the magnetic recording layer at room temperature, with contour lines. Besides, the black circles in FIGS. 3 to 7 represent the compositions of the respective samples described in Tables 2 to 6.

TABLE 2
Magnetic recording medium (x/y is about 0.73)

| | Composition | | | | Hk | dHk/dT | | |
|---|---|---|---|---|---|---|---|---|
| | (atom %) | | | Tc | @RT | (Oe/° C.) | | |
| sample | Fe | Pt | Ru | (° C.) | (kOe) | Tc − 60° C. | Tc − 40° C. | Tc − 20° C. |
| A1 | 42.3 | 57.7 | 0.0 | 373 | 41.7 | 143 | 176 | 248 |
| A2 | 42.2 | 57.5 | 0.3 | | 39.9 | | | |
| A3 | 42.0 | 56.9 | 1.1 | 362 | 40.8 | 192 | 235 | 332 |
| A4 | 41.5 | 56.2 | 2.3 | | 40.3 | | | |
| A5 | 40.0 | 56.0 | 4.0 | 308 | 43.2 | 185 | 227 | 320 |
| A6 | 39.7 | 54.2 | 6.1 | | 46.1 | | | |
| A7 | 38.6 | 53.0 | 8.5 | | 42.9 | | | |
| A8 | 37.5 | 51.3 | 11.2 | 251 | 38.2 | 185 | 227 | 321 |
| A9 | 35.9 | 49.9 | 14.2 | | 41.1 | | | |
| A10 | 34.6 | 48.0 | 17.4 | | 39.4 | | | |
| A11 | 33.3 | 46.0 | 20.7 | | 38.1 | | | |
| A12 | 31.6 | 44.4 | 24.0 | | 40.1 | | | |

TABLE 3
Magnetic recording medium (x/y is about 0.84)

| | Composition | | | | Hk | dHk/dT | | |
|---|---|---|---|---|---|---|---|---|
| | (atom %) | | | Tc | @RT | (Oe/° C.) | | |
| sample | Fe | Pt | Ru | (° C.) | (kOe) | Tc − 60° C. | Tc − 40° C. | Tc − 20° C. |
| B1 | 45.5 | 54.5 | 0.0 | 412 | 47.2 | 154 | 189 | 267 |
| B2 | 44.4 | 54.9 | 0.7 | | 48.5 | | | |
| B3 | 44.9 | 53.1 | 2.0 | 361 | 49.1 | 166 | 203 | 287 |
| B4 | 43.4 | 52.7 | 3.9 | 345 | 46.6 | 163 | 200 | 282 |
| B5 | 42.8 | 50.9 | 6.3 | 290 | 37.2 | 136 | 166 | 235 |
| B6 | 41.8 | 49.4 | 8.8 | 246 | 40.1 | 182 | 223 | 316 |
| B7 | 40.0 | 48.2 | 11.9 | 219 | 39.4 | 178 | 218 | 309 |
| B8 | 39.1 | 45.7 | 15.2 | | 37.5 | | | |
| B9 | 37.2 | 44.8 | 18.0 | | 35.2 | | | |
| B10 | 36.2 | 42.8 | 21.0 | | 35.6 | | | |
| B11 | 34.7 | 40.8 | 24.4 | | 37.3 | | | |
| B12 | 33.2 | 39.1 | 27.7 | | 33.1 | | | |

TABLE 4
Magnetic recording medium (x/y is about 0.97)

| | Composition | | | | Hk | dHk/dT | | |
|---|---|---|---|---|---|---|---|---|
| | (atom %) | | | Tc | @RT | (Oe/° C.) | | |
| sample | Fe | Pt | Ru | (° C.) | (kOe) | Tc − 60° C. | Tc − 40° C. | Tc − 20° C. |
| C1 | 48.9 | 51.1 | 0.0 | 419 | 55.0 | 161 | 197 | 278 |
| C2 | 48.8 | 50.6 | 0.6 | | 61.7 | | | |
| C3 | 48.7 | 49.4 | 1.9 | 399 | 61.2 | 202 | 248 | 351 |
| C4 | 47.5 | 48.8 | 3.7 | | 58.2 | | | |
| C5 | 46.4 | 47.5 | 6.2 | 339 | 55.3 | 202 | 248 | 350 |
| C6 | 44.9 | 46.2 | 8.9 | | 55.7 | | | |
| C7 | 43.1 | 45.0 | 11.9 | 327 | 50.8 | 214 | 262 | 370 |
| C8 | 41.9 | 43.0 | 15.1 | 267 | 50.7 | 189 | 231 | 327 |
| C9 | 39.8 | 42.0 | 18.2 | | 47.9 | | | |
| C10 | 38.1 | 40.6 | 21.3 | | 40.7 | | | |
| C11 | 36.9 | 38.5 | 24.6 | | 38.3 | | | |
| C12 | 35.8 | 36.7 | 27.5 | | 38.7 | | | |

TABLE 5
Magnetic recording medium (x/y is about 1.15)

| | Composition | | | | Hk | dHk/dT | | |
|---|---|---|---|---|---|---|---|---|
| | (atom %) | | | Tc | @RT | (Oe/° C.) | | |
| sample | Fe | Pt | Ru | (° C.) | (kOe) | Tc − 60° C. | Tc − 40° C. | Tc − 20° C. |
| D1 | 53.2 | 46.8 | 0.0 | 490 | 59.0 | 180 | 220 | 311 |
| D2 | 53.2 | 46.2 | 0.6 | | 65.2 | | | |
| D3 | 52.7 | 45.4 | 1.9 | 413 | 61.6 | 202 | 248 | 351 |
| D4 | 51.2 | 45.1 | 3.7 | | 59.4 | | | |
| D5 | 50.1 | 43.7 | 6.1 | 385 | 58.3 | 203 | 248 | 351 |
| D6 | 48.5 | 42.9 | 8.6 | 402 | 60.9 | | | |
| D7 | 46.9 | 41.5 | 11.6 | 292 | 56.8 | 222 | 272 | 385 |
| D8 | 45.6 | 39.5 | 14.9 | 335 | 54.5 | 208 | 254 | 360 |
| D9 | 43.7 | 38.7 | 17.6 | | 51.7 | 199 | 244 | 345 |
| D10 | 42.7 | 37.0 | 20.3 | | 43.7 | | | |
| D11 | 41.1 | 35.4 | 23.5 | | 40.9 | | | |
| D12 | 39.7 | 33.0 | 26.4 | | 42.6 | | | |

TABLE 6
Magnetic recording medium (x/y is about 1.32)

| | Composition | | | | Hk | dHk/dT | | |
|---|---|---|---|---|---|---|---|---|
| | (atom %) | | | Tc | @RT | (Oe/° C.) | | |
| sample | Fe | Pt | Ru | (° C.) | (kOe) | Tc − 60° C. | Tc − 40° C. | Tc − 20° C. |
| E1 | 56.4 | 43.6 | 0.0 | 424 | 46.6 | 151 | 184 | 261 |
| E2 | 55.9 | 43.2 | 0.9 | | 44.9 | | | |
| E3 | 55.5 | 41.8 | 2.7 | 379 | 46.3 | 157 | 193 | 273 |
| E4 | 54.1 | 40.9 | 5.0 | | 51.2 | | | |
| E5 | 52.4 | 40.0 | 7.6 | 330 | 52.2 | 191 | 233 | 330 |
| E6 | 50.8 | 38.8 | 10.4 | | 53.2 | | | |
| E7 | 49.2 | 37.6 | 13.2 | 307 | 45.6 | 179 | 219 | 310 |
| E8 | 48.1 | 35.9 | 16.0 | | 52.0 | | | |
| E9 | 46.2 | 35.0 | 18.9 | | 44.9 | | | |
| E10 | 44.6 | 33.5 | 21.9 | | 40.5 | | | |
| E11 | 42.9 | 32.0 | 25.1 | | 40.2 | | | |
| E12 | 40.7 | 30.5 | 28.8 | | 47.2 | | | |

### EVALUATION

As shown in FIG. 3, the Curie temperature Tc of the magnetic recording layer 30 is tend to lower, as the Ru content in the magnetic recording layer 30 increases. Further, when the similar amount of Ru is used, the maximum value of the Curie temperature Tc of the magnetic recording layer 30 is located in the neighborhood of the point where x/y is about 1.15. Then, the Curie temperature Tc lowers, if either of the Fe content x or the Pt content y increases from the composition exhibiting the maximum value. Besides, it is understood that variation in the value of the Curie temperature Tc is smaller in the case where Pt in the ordered alloy is substituted with Ru, compared with the case where Fe in the ordered alloy is substituted with Ru.

On the other hand, as shown in FIG. 7, it is understood that the value of the anisotropic magnetic field Hk increases, as the Ru content z decreases, and as the ratio x/y of the Fe content to the Pt content approaches to 1.0. Further, it is understood that variation in the value of the anisotropic magnetic field Hk is smaller in the case where Pt in the ordered alloy is substituted with Ru, compared with the case where Fe in the ordered alloy is substituted with Ru.

Further, FIGS. 4 to 6 show the relationship between the composition of the magnetic recording layer 30 and the gradient of the anisotropic magnetic field to temperature variation dHk/dT. FIG. 4 shows values at the temperature 60° C. lower than the Curie temperature Tc, FIG. 5 shows values at the temperature 40° C. lower than the Curie temperature Tc, and FIG. 6 shows values at the temperature 20° C. lower than the Curie temperature Tc. Besides, the region satisfying the equations (i) to (v) is indicated with a hexagon with broken lines in FIGS. 4 to 6.

The values of dHk/dT at the respective temperature shows similar tendency. In particularly, the value of dHk/dT at the respective temperature is maximized in the case where z is about 12 and x/y is from about 0.9 to about 1.15. It is understood that dHk/dT not less than 170 Oe/° C. (13.5 A/mm·° C.) necessary to reduction of the bit transition width is achieved by having the composition within the region satisfying the equations (i) to (v), even at the temperature 60° C. lower than the Curie temperature Tc shown in FIG. 4 where magnetic recording is the most difficult.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. All of the patent applications and documents cited herein are incorporated herein by reference in their entirety.

What is claimed is:

1. A magnetic recording medium comprising a non-magnetic substrate and a magnetic recording layer, wherein the magnetic recording layer comprises an ordered alloy containing Fe, Pt and Ru, the ordered alloy comprises x atom % of Fe, y atom % of Pt and z atom % of Ru based on the total number of the Fe, Pt and Ru atoms, and x, y and z satisfy the following equations (i) to (v):
0.85≦x/y≦1.3; (i)
x≦53; (ii)
y≦51; (iii)
0.6≦z≦20; and (iv)
x+y+z=100. (v)

2. The magnetic recording medium according to claim 1, wherein the ordered alloy is a L1₀ type ordered alloy.

3. The magnetic recording medium according to claim 1, wherein the magnetic recording layer has a granular structure comprising magnetic crystal grains comprising the ordered alloy and a non-magnetic crystal grain boundary, wherein the non-magnetic crystal grain boundary comprises at least one material selected from carbon, boron, a carbide, an oxide, and a nitride.

4. The magnetic recording medium according to claim 1, wherein the magnetic recording layer comprises a plurality of magnetic layers, and at least one of the magnetic layers is a magnetic layer comprising the ordered alloy.

5. The magnetic recording medium according to claim 4, wherein the ordered alloy is a L1₀ type ordered alloy.

6. The magnetic recording medium according to claim 4, wherein the magnetic layer comprising the ordered alloy has a granular structure comprising magnetic crystal grains and a non-magnetic crystal grain boundary, wherein the non-magnetic crystal grain boundary comprises at least one material selected from carbon, boron, a carbide, an oxide, and a nitride.
